(19) United States
(12) Patent Application Publication
(10) Pub. No.: US 2011/0247601 A1
(43) Pub. Date: Oct. 13, 2011

(54) TWO-CYCLE ENGINE AND LOW EMISSION CONTROL SYSTEM

(76) Inventor: Imack Laydera-Collins, Benton, LA (US)

(21) Appl. No.: 13/080,936

(22) Filed: Apr. 6, 2011

Related U.S. Application Data
(60) Provisional application No. 61/321,528, filed on Apr. 7, 2010.

(51) Int. Cl. F02B 33/04

(52) U.S. Cl. 123/73 PP

(57) ABSTRACT

A two-cycle engine including exhaust, air inlet, scavenging and air/fuel intake windows disposed in the cylinder wall, a reciprocating piston driving a crankshaft, and curved gas-conveying channels connecting the crankcase chamber with the cylinder bore, the channels being opened by the reciprocating piston and the channels producing centrifugation of gases circulating therein to produce lean and rich components of an air/fuel mixture, wherein the lean component is circulated in a region of the combustion chamber remote from the exhaust window for promoting reduced combustion residues.

### CROSS-REFERENCE TO RELATED APPLICATION

This application claims priority to U.S. Provisional Application No. 61/321,528 filed Apr. 7, 2010 and entitled “LOW EMISSION CONTROL SYSTEM FOR A TWO-CYCLE ENGINE”, the contents of which are incorporated by reference herein.

### BACKGROUND

Two-cycle engines are preferred power sources for power tools due to their high power-to-weight ratios and compact size. Recent environmental concerns have challenged traditional technology to lower raw hydrocarbon exhaust emissions. As it is known, the typical design of a two-cycle engine uses a stream of new air/fuel mixture to finish evacuating burned gases left in the cylinder chamber from the previous combustion cycle. Because the exhaust port remains open during the time the scavenging ports are open, some of the un-burned scavenging gases (i.e. air/fuel mixture) are able to escape through the exhaust port to the atmosphere, creating pollution and reducing fuel efficiency.

There has been a continued effort to increase fuel efficiency while minimizing raw hydrocarbon losses. Such methods include “stratified scavenging” in which a “puff” of air is introduced in advance of the transference of the air/fuel mixture into the cylinder to evacuate burnt gases inside the cylinder and avoid the loss of raw fuel, using transfer ports that direct the scavenging flow efficiently through the cylinder chamber, addressing unburned hydrocarbon emissions as a result of the extinguishing of the flame as it approaches the relatively cold walls of the cylinder, addressing un-reacted fuel in piston ring crevices, and providing a layer of air as a barrier between the cylinder walls and the air/fuel mixture.

While the foregoing methods are advantageous in some aspects, they are disadvantageous in others, and thus there continues to be a need for increasing fuel efficiency while minimizing raw hydrocarbon losses in two-cycle engines.

### BRIEF SUMMARY

In one aspect, a low-emission two-cycle, spark ignited, crankcase-scavenged engine is provided herein.

In another aspect, the engine utilizes stratified scavenging, combustion mapping and gas dynamics to achieve low levels of raw hydrocarbon emissions and nitrogen oxides.

In a further aspect, the engine utilizes symmetrical semi-circular scavenging passages to create significant centrifugal force to separate an air/fuel mixture into a bi-layer compound of lean and rich fuel concentrations.

In a further aspect, the bi-layer of air/fuel mixture is discharged against the back wall of the cylinder opposite the exhaust port, minimizing the quenching of the wall surface. Further, the scavenging passages of the engine remain isolated from the crankcase for a predetermined period of time before the transfer port windows open. A higher crankcase pressure is generated because the scavenging ports are isolated from the crankcase volume at the moment of compression.

In a further aspect, once the transfer ports are opened a blow-down wave of exhaust gases travels across the passage, increasing the pressure inside the scavenging passages without pushing significant portions of the mixture inside the piston internal cavity. As the pressure wave stops, the flow is reversed and a column of gases is directed by ports into the combustion chamber. As the blown-down combustion gases are ejected out of the scavenging passages and into the combustion chamber, the column of stratified air/fuel mixture follows and continues to circulate towards the back wall of the cylinder opposite the exhaust port. This circulation continues into a loop around the upper portion of the combustion chamber and finally towards the exhaust port, evacuating the residual exhaust gases from the previous power cycle.

In a further aspect, the air/fuel mixture is circulated at great speed through the scavenging passages. The centrifugal force induced into the passages forces the heavy particles of fuel to circulate near the outer wall of their circular passage, and the light particles to stay closer to the center of rotation near the inner wall of their circular passage. When the two streams enter into the cylinder chamber, the leaner or lighter components travel towards the far end of the port window and the heavier component is discharged behind the lighter component in relation to the back wall of the cylinder. During the discharge of the mixture layers, the leaner component hits the back wall of the cylinder following the same loop around the combustion chamber and the richer components remain in a shorter path over the central part of the cylinder chamber.

In a further aspect, during the compression cycle, the cluster of lean mixture remains in the upper zone of the combustion chamber dome surrounding the spark plug and the rich mixture remains nearby the hot piston crown, and heat migration from the piston head in contact with the richer mixture produces vaporization of the fuel droplets, which results in added exposure of the fuel molecules with available free oxygen, allowing higher efficiency on the combustion.

In a further aspect, at the moment of ignition, the combustion is initiated into an oxygen rich zone resulting in a faster propagation around the upper walls of the combustion chamber with minimal residual fuel over the walls. Following, the finely vaporized rich cluster ignites providing a progressive expansion wave with maximum oxidation of the free fuel molecules. The process minimizes the portion of unburned hydrocarbons (HC) originated on the incomplete combustion.

In a further aspect, the bi-layer air/fuel mixture at the moment of discharge into the combustion chamber can be combined with a process of introducing a column of air inside the circular scavenging passages with the purpose of further reducing the exhaust emissions. An air head can be introduced by creating a timed suction pulse through the circular passages, which in cooperation with a piston cavity, transmits the suction pulse to a source of atmospheric air into the engine, which then fills the volume of the circular scavenging passages.

In a further aspect, at the moment of evacuating the burnt gases from the engine, the column of air is pushed out of the scavenging passages by the pressure of the gases inside the crankcase. The column of air is separated from any residual fuel by the centrifugal force generated inside the circular scavenging passages. This results in an airhead with substantially less residual fuel. The airhead is followed by the bi-layered stream of air/fuel mixture, thus further minimizing the unburned fuel bypassed by the two-cycle scavenging process.

In a further aspect, the low pressure of gas stored in the scavenging passages allows a substantially strong blow-down pulse into the scavenging passages, which increases the pressure inside the transfer passages. This higher pressure-differential increases the speed of the gases circulating through the scavenging passages, enhancing the fuel zone separation and maintaining gas flow direction within the cylinder chamber to improve scavenging and trapping efficiency.

In a further aspect, the piston skirt opening in cooperation with the crankcase inlet window allows the selective discharge of air/fuel mixture from the crankcase into the scavenging passages, which creates an air/fuel mixture path through the internal cavity of the piston that is fairly narrow. This structure allows the stratification between the air/fuel mixture to be maintained even if the volume of air is pushed backwards into the crankcase by the blow-down gases. The scavenging passages communication with the crankcase is opened around a very turbulent chamber occupied by the crankshaft counterweights.

In a further aspect, the transfer passages communicate with the crankcase through a window at the top section of the piston skirt. This configuration allows a substantial flow of substantially cool gases in the nearby zone of the hottest piston-cylinder area. This mechanism allows lowering the temperature on that zone where the majority of engine seizing occurs as a consequence of lubricant breakdown under high temperatures. Furthermore, the high circulation of cooler gases throughout the piston crown improves the lubrication on the wristpin bearing, thus extending engine life. Further, the pressurized air/fuel mixture from the crankcase allows beneficial leakage around the piston window perimeter, thus providing extra lubrication for the contact surfaces of the piston and cylinder wall during the work and compression stroke.

To achieve the foregoing and other aspects and advantages, a two-cycle internal combustion engine is provided herein including a cylinder in which a combustion chamber is formed, a crankcase enclosing a crankcase chamber and having an outlet for removal of burnt gases, a crankshaft rotatively mounted in the crankcase, a piston reciprocally disposed in the cylinder and connected to the crankshaft for driving the crankshaft, the piston dilimiting the combustion chamber, and a pair of at least partially circular gas-conveying channels each connecting the crankcase chamber to the combustion chamber.

The scavenging passages are symmetrically located external of the combustion chamber and communicate with the combustion chamber through scavenging ports, the scavenging passages connecting to the crankcase chamber through crankcase inlet windows and piston windows, wherein the piston windows in cooperation with the crankcase inlet windows allow the flow of gases through the scavenging passages. The engine further includes air intake ports for admitting air through air passages.

In operation, the gas-conveying channels are selectively opened by the piston when the piston reciprocates, each gas-conveying channel produces substantial centrifugation of a gaseous mixture of air and fuel circulating therein to produce a stratified gaseous mixture having a fuel-lean component and a fuel-rich component, each gas-conveying channel supplies firstly fuel-free gas for a scavenging process to evacuate the burnt gases though the outlet of the crankcase and secondly the stratified mixture for combustion, and for the duration of a scavenging process, the fuel-free gas flows into the combustion chamber from the gas-conveying channels in a region of the combustion chamber remote from the outlet, and, following the fuel-free gas, the stratified mixture flows into the combustion chamber from the gas-conveying channels such that the lean component is circulated in a region of the combustion chamber remote from the outlet thereby promoting reduced combustion residues.

In another embodiment, provided herein is a method of controlling a low-emission two-cycle engine including providing a two-cycle engine having a pair of at least partially circular scavenging passages each connecting the crankcase chamber to the combustion chamber, the scavenging passages communicating with the combustion chamber through scavenging ports and connecting to the crankcase chamber through crankcase inlet windows and piston windows, wherein the piston windows in cooperation with the crankcase inlet windows allow the flow of gases through the scavenging passages, and wherein the scavenging passages are selectively opened by the piston when the piston reciprocates.

The method further includes moving the piston toward a first position to close the scavenging ports, exhaust ports and crankcase inlet windows, filling the scavenging passages with an air/fuel mixture, and moving the piston to a second position to align air intake ports with piston air cavities, and the piston air cavities with the scavenging ports, while simultaneously opening the crankcase inlet windows to fluid communication with the scavenging passages to cause a stream of the mixture to enter the crankcase chamber.

The method further includes compressing the mixture into the combustion chamber and igniting the mixture to displace the piston toward the second position, causing a skirt of the piston to close the crankcase inlet windows and crankcase intake ports and the piston air cavities to close the air intake ports. The method further including the piston near the second position opening the exhaust ports to allow burnt gases to start exiting the engine, and subsequently the scavenging ports and crankcase inlet windows to opened. The method further including exhaust gases entering the scavenging ports to push existing air volume inside the scavenging passages towards the crankcase chamber, and after pressure equalizes, gases from the scavenging ports start displacing remaining gases inside the cylinder chamber, and at the end of a scavenging period a bi-layer air and fuel mixture is transferred into the combustion chamber.

Additional features, aspects and advantages are set forth in the detailed description which follows, and in part will be readily apparent to those skilled in the art from that description or recognized by practicing the invention as described herein.

### BRIEF DESCRIPTION OF THE DRAWINGS

The embodiments described in detail below are better understood when the following detailed description is read in conjunction with the accompanying drawings in which:

FIG. 1 is a schematic diagram of an engine illustrating the physical process of fuel stratification;

FIG. 2 is a cross-sectional view of the engine taken along the axis of the cylinder and parallel to the crankshaft;

FIG. 3 is a rear elevation view of the partially assembled engine illustrating a circular scavenging passage;

FIGS. 4a and 4b illustrate piston structure without and with air stratification, respectively;

FIGS. 5a and 5b are cross-sectional views of the cylinder perpendicular to the crankshaft shown without and with air stratification, respectively;

FIGS. 6a and 6b are schematic diagrams illustrating mixture distribution inside the scavenging passages and the combustion chamber, with FIG. 6a showing the piston at bottom dead center position (BDCP) and FIG. 6b showing the piston at top dead center position (TDCP);

FIG. 7 illustrates the shape of the scavenging passage; and

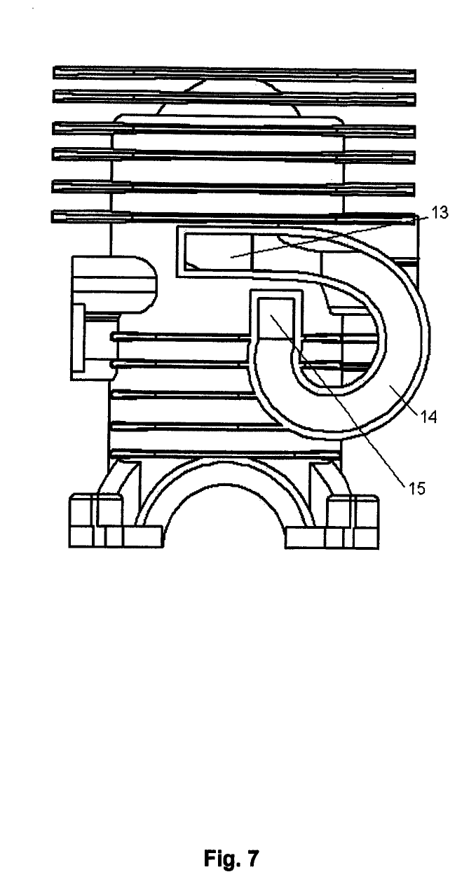

FIG. 8 is a perspective view of the engine.

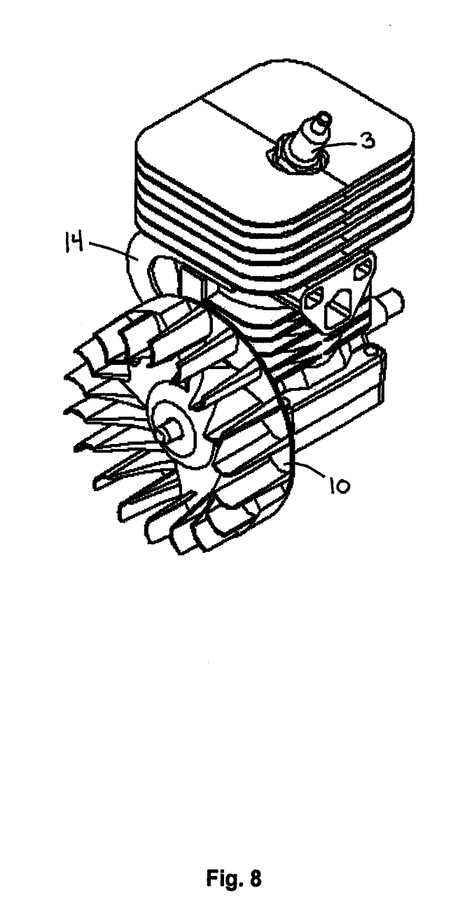

### DESCRIPTION OF THE EMBODIMENTS

Provided herein are embodiments of a low-emission two-cycle engine and low emission control system for a two-cycle engine that utilizes aspects of stratified scavenging, combustion mapping and gas dynamics to achieve low levels of raw hydrocarbon emissions and nitrogen oxides. Among other components, the engine generally includes symmetrical semi-circular scavenging passages to create significant centrifugal force to separate an air/fuel mixture into a bi-layer compound of lean and rich fuel concentrations.

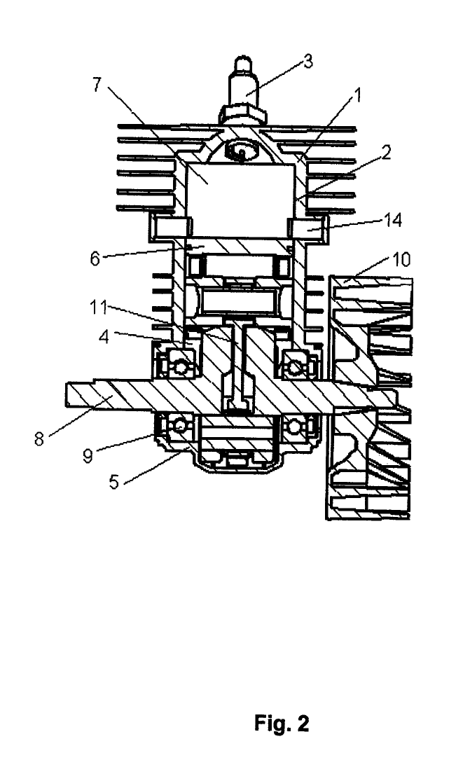

Referring to FIG. 2, a cross-sectional view of one embodiment of a two-cycle engine is shown generally including a cylinder block 1 having a cylinder bore 2 defined therein, an ignition plug 3 mounted atop of the cylinder block 1, and a crankcase chamber 4 defined within a crankcase cap 5 and the cylinder block 1 being fixedly mounted thereon. Within the cylinder bore 2, accommodated therein is a piston 6 for reciprocating movement in the axial direction. The piston 6 cooperates with the cylinder bore 2 to form a variable capacity combustion chamber 7. The combustion chamber 7 and the crankcase chamber 4 are separated by the piston 6. A crankshaft 8 free to rotate is supported within the crankcase cap 5 and cylinder block 1 structure by means of crankshaft bearings 9. At one end of the crankshaft is a flywheel 10 for providing the required rotational inertia. The crankshaft is coupled to the piston 6 by means of a connecting rod 11. The crankshaft 8 converts the reciprocating motion of the piston 6 into rotational motion.

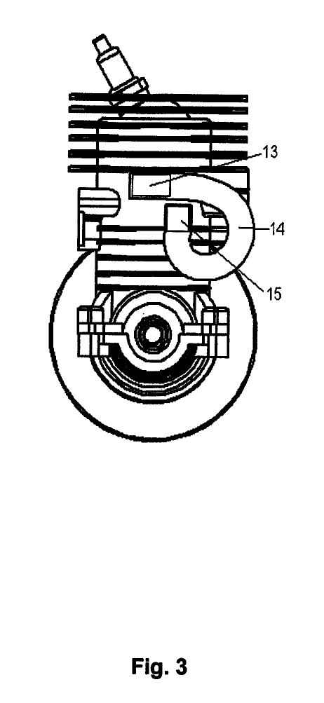

Referring specifically to FIGS. 2-4, the combustion chamber 7 is selectively connected to the crankcase chamber 4 through circular scavenging passages 14, also referred to herein as “gas-conveying channels”, symmetrically located external of the cylinder bore 2. The scavenging passages 14 can be arcuate tubes defining a chamber or channel therein, and in a specific embodiment, have at least about 180-degrees of turn path. The circular scavenging passages 14 selectively communicate with the combustion chamber 7 through scavenging ports 13. The scavenging passages connect to the crankcase chamber 4 through crankcase inlet windows 15 and piston windows 17. The opened ends of the scavenging passages 14 can be controlled to provide improved stratification between the air contained therein and the air/fuel mixture. The piston 6 has a piston window 17 on the piston skirt 16. The piston window 17 in cooperation with the crankcase inlet window 15 allows the selective flow of gases through the circular scavenging passages 14. In a specific embodiment, the scavenging ports 13 have a trapezoidal shape to allow early discharge of the heavier component of the mixture of gases.

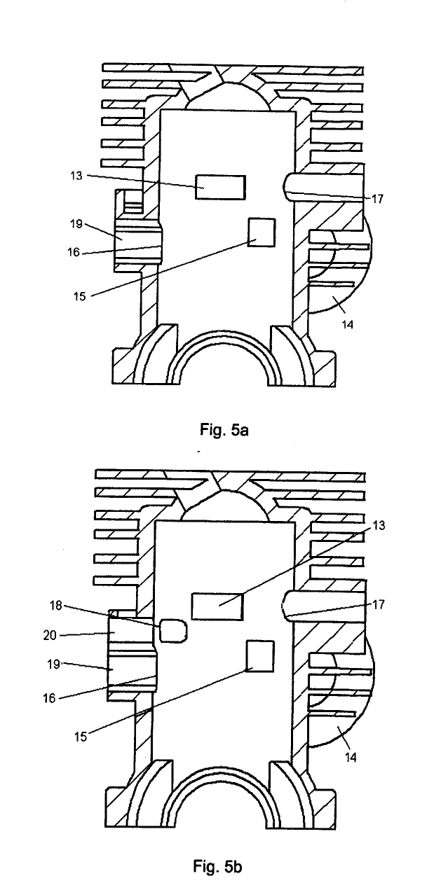

To further illustrate the elements of the two-cycle engine, FIGS. 5a and 5b show the multiple openings over the cylinder bore walls. Specifically, FIG. 5a illustrates the cylinder bore of a first embodiment and FIG. 5b illustrates the cylinder bore of a second embodiment. These openings on the cylinder wall, referred to herein as ‘ports’, selectively cooperating with the piston external walls, allow the exchange of gases with the atmosphere and internal engine compartments. The crankcase intake port 16 allows the introduction of an air/fuel mixture into the crankcase chamber 4. The intake port 16 is in fluid communication with a carburetor (not shown) through the intake passage 19. The communication of the intake passage 19 is selectively controlled by the reciprocating motion of the piston 6 within the cylinder bore. The exhaust port 17 allows the burnt gases from the combustion process to be expelled into the atmosphere through a muffler (not shown).

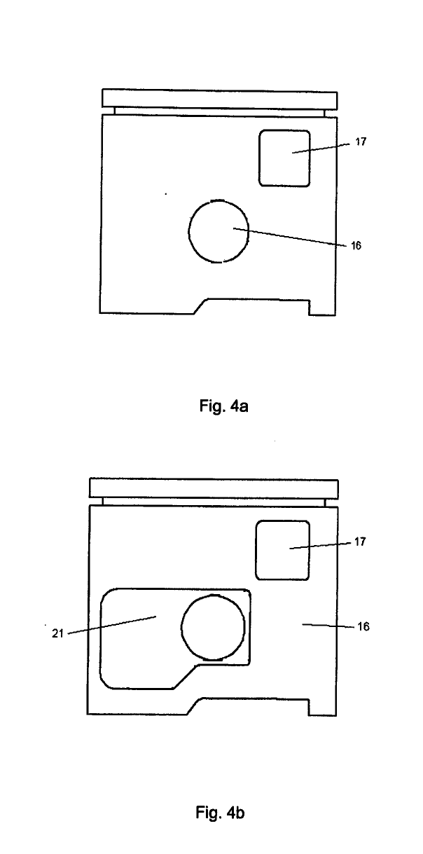

The scavenging ports 13 are located symmetrical to a plane perpendicular to the crankshaft 8. The scavenging ports 13 are in fluid communication with the crankcase through circular scavenging passages 14 located on each side of the external walls of the cylinder 1. Each scavenging passage 14 is in fluid communication with the crankcase chamber 4 through a crankcase inlet window 15 on the cylinder wall. The piston skirt contains a matching window 17 that allows the selective communication of the crankcase inlet window with the crankcase chamber 4. FIG. 5b shows an additional port called the air intake port 18. This port allows the admission of pure air from the atmosphere through air passages 20. This air port 18 in cooperation with the air cavities 21 located on the piston skirt 16 (FIG. 4), allows the suction from the crankcase chamber 4 to be transmitted through the circular scavenging passages 14 to the scavenging ports 13. The air cavities 21 on the piston skirt 16 selectively allow the communication of the air ports 18 with the scavenging ports 13. Once these elements are aligned, the air from the air passages 20 flows into the circular scavenging passages 14.

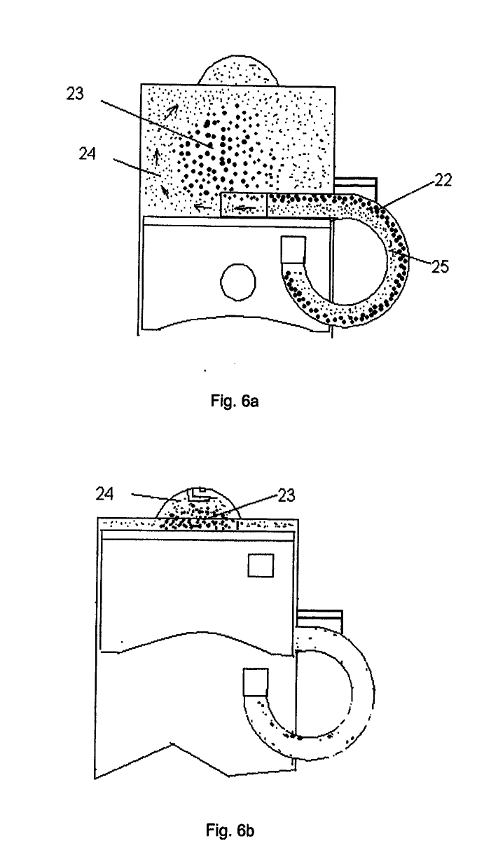

Referring to FIG. 6, the scavenging passages 14 are circular in shape. The circular shape produces a fairly long path exposed to the centrifugal force created by the scavenging gases circulating through the scavenging passages 14 under high speed during the scavenging period. Under the influence of centrifugal force, the air/fuel mixture is divided into a lean mixture layer 25 that tends to concentrate towards the internal circular walls, and a rich layer mixture 22 that tends to concentrate in the outer walls of the circular path.

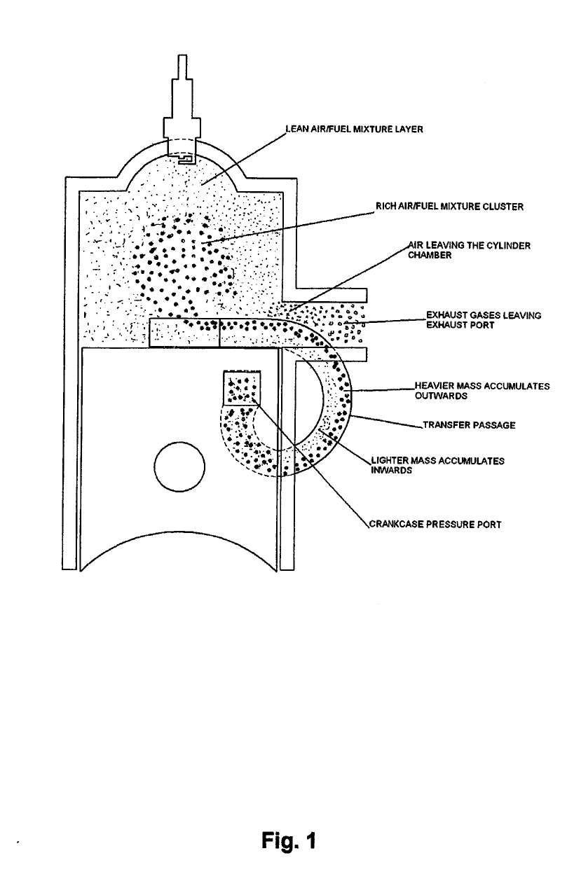

As the engine starts the scavenging period, the piston inlet windows 17 align with the cylinder inlet windows 15. Simultaneously, the scavenging ports 12 are opened by the top edge of the crown of the piston 5. Under crankcase pressure, the air/fuel mixture is pushed through the scavenging passages 14 until they exit into the combustion chamber 7 through the scavenging ports 13. As the mixture travels through the circular passages the level of lean-rich separation increases. Just before entering into the cylinder chamber through the scavenging ports 13, as shown in FIGS. 1 and 6, the lean portion of the mixture 24 is propelled by the directional port towards the back wall of the cylinder 1, while the rich mixture 23 tends to concentrate at the central area of the combustion chamber. FIG. 1 illustrates the distribution of mass at the time of ejection of the two components of the air/fuel mixture.

The cool lean mixture collides against the cylinder back wall decreasing the quenching zones, thus minimizing the effect of fuel particles adhering to the cold cylinder walls. After the transfer ports close, the two-layer mixture is compressed into the smaller volume of the combustion chamber 7. Here, the lean mixture is in contact with spark plug electrodes, the source of ignition.

Combustion is initiated under conditions very close to a stoichiometric point. This generates a near perfect combustion that expands towards the center rich zone. The rich zone is under evaporation from the contact with the hot surface of the piston crown. The richer mixture zone then burns efficiently seeking for free oxygen, which is provided by the scavenging air residues in the vicinity of the exhaust port. Another benefit of the fuel mixture stratification is the concentration of lean air mixture around the squish area, which is of significant advantage on reducing residual combustion fuel. Since the combustion is performed with less quenching zones, the result is a decreased amount of carbon monoxide (CO), nitric oxide (NO) and hydrocarbons (HC). This also results in a high thermal efficiency.

The air stratification used on two-cycle engines as a mechanism to reduce exhaust emissions can produce an unwanted lag on the acceleration due to residual air pockets inside the combustion space. This disadvantage is improved by reducing the amount of air used for preliminary scavenging, since a layer of lean air/fuel is produced behind the volume of pure air ejected from the scavenging passages. In contrast to related technology that uses over 40% of the engine displacement on air volume, the present engine uses under 35% of the engine displacement on scavenging air.

Another advantage of the engine configuration is the proximity of the piston intake window to the portion of the piston skirt in contact with the exhaust port and surrounding areas. Most engine failures occur by seizing of the piston and cylinder walls over and below the exhaust port due to lubricant breakdown under excessive temperatures and the corresponding friction created by the thrust of the piston skirt over the cylinder walls. When allowing the circulation of the cold air/fuel mixture through the piston inner cavity and forcing it through windows located through the piston skirt near the points where maximum piston temperatures usually occurs, there is a cooling effect that lowers the level of temperature to a survivable range under rigorous loads and speed conditions. In addition to the cooling effect of the air/fuel mixture circulation, additional lubrication throughout the piston thrust area is enhanced, resulting in minimization of friction and increasing engine efficiency and protecting the unit against failure.

Another benefit of the engine is the mechanism used to store and release the atmospheric air used for preliminary scavenging of the exhaust gases. When the piston is ascending towards the TDCP, the opened cylinder intake window, through the scavenging passage, to the scavenging port, transfers the negative pressure in the crankcase. In this specific position, the piston air cavities 21 align with the air intake ports 18 and the scavenging ports, allowing the suction of air. The suction timing and air circulation through pre-calculated air passages allows partial filling of the scavenging passage with pure air. When the piston 6 starts descending towards BDCP, since the access to the scavenging passage is controlled by the piston skirt, the volume of air remains under negative pressure until it is time for the scavenging period. This causes burnt combustion gases to enter into the passage, slightly delaying the scavenging real time during the blow-down period, while allowing most of the combustion gases to exit the engine through the exhaust port. At this point the scavenging passage is filled with pressurized exhaust gases and air.

When pressure equalization occurs, a few degrees after scavenging port opening, the rush of gases starts inside the circular scavenging passage. First, a mixture of exhaust gases and air starts pushing the residues from the combustion cycle out towards the exhaust port. Then, a section of air follows. At this point a very lean air/fuel mixture starts coming out due to the interface air/mixture. Then, finally comes the air/fuel mixture in the two concentrations described previously.

Unlike the related art in which the column of air is pressurized by the crankcase, resulting in portions of air being pushed inside the crankcase by the blow-down force, and mix with air/fuel mixture, the air content of the scavenging passages on the engine of the present invention is preserved. As a reassurance for the preservation of unmixed air volume, the piston inner cavity acts like an extension of the scavenging passage, allowing the stratification between air and fuel mixture.

The engine operates as follows. As the piston 6 moves toward the TDCP, it closes the scavenging ports 13, exhaust ports 17 and cylinder intake window 15. At this point the scavenging passages 14 are filled with lightly pressurized air/fuel mixture. As the piston 6 approaches the TDCP, the air inlet ports 20 are aligned with the piston air cavities 21, and the piston air cavities 21 with scavenging ports 13. Simultaneously, the cylinder inlet windows 15 open the communication of the scavenging passages 14 with the crankcase chamber 4. This allows the negative pressure inside the crankcase to suck-in the air/fuel mixture inside the passages, while allowing air to replace it.

At the same time, the crankcase intake port 16 is opened, causing a stream of air/fuel mixture to enter the crankcase chamber 4. While all these fluid transfer mechanisms are taking place, the piston 6 is compressing the previously admitted air/fuel mixture into the combustion chamber 7. The ignition of the mixture produces the work stroke, displacing the piston 6 towards the BDCP. During its travel towards the BDCP, the bottom edge of the piston skirt 16 closes the crankcase inlet window 15 and the inlet port 16. At the same time the upper edge of the piston air cavity 21 closes the air inlet port 20. All the crankcase chamber 4 openings are closed and internal crankcase pressurization starts.

Subsequently, during the cycle near the BDCP, the piston 6 top edge opens the exhaust port and the high temperature burnt gases under pressure start exiting the engine through the exhaust port. When nearly 30% of the exhaust port area is opened, the pressure inside the combustion chamber 7 is drastically reduced. Following, the scavenging ports 13 and crankcase inlet window 15 are opened. Since the pre-existing pressure inside the cylinder chamber is still higher than the crankcase pressure, blow down occurs and exhaust gases enter the scavenging ports, pushing the existing air volume inside the scavenging passages 14 towards the crankcase chamber 4. After pressure equalizes, gases from the scavenging ports start displacing the remaining gases inside the cylinder chamber. At the end of the scavenging period a bi-layer distribution of rich mixture-lean mixture is transferred into the combustion chamber 7. The compression cycle then begins again.

What is claimed is:

1. A two-cycle internal combustion engine, comprising:
a cylinder block having a cylinder bore and a combustion chamber, wherein an exhaust window, an air inlet window, a scavenging window and an air/fuel intake window are disposed in a wall of the cylinder bore;
a piston reciprocally disposed in the cylinder bore and delimiting the combustion chamber, the piston having a wall for guiding the piston along the cylinder bore, and the piston being connected to and driving a crankshaft rotatably mounted in a crankcase enclosing a crankcase chamber; and
a plurality of curved gas-conveying channels connecting the crankcase chamber with the cylinder bore;
wherein the curved gas-conveying channels are selectively opened by the reciprocating piston;
wherein the curved gas-conveying channels include means to produce substantial centrifugation of gases circulating therein to produce lean and rich components of an air/fuel mixture; and
wherein the lean component of the air/fuel mixture is circulated in a region of the combustion chamber remote from the exhaust window for promoting reduced combustion residues.

2. The engine according to claim 1, further comprising means for selectively establishing fluid communication of the air inlet window with the curved gas-conveying channels.

3. The engine according to claim 1, wherein curved gas-conveying channel communication with the crankcase chamber is selectively opened and closed by reciprocating motion of the piston wall.

4. The engine according to claim 1, wherein the scavenging window has a trapezoidal shape.

5. The engine according to claim 1, wherein the piston wall has a plurality of cavities and windows for selective timed communication with the curved gas-conveying channels and the air inlet window.

6. The engine according to claim 1, wherein the curved gas-conveying channels include means to control both of its open ends for improved stratification between air contained in the channels and the air/fuel mixture.

7. A stratified scavenged two-cycle internal combustion engine, comprising:
a cylinder block having a cylinder bore, the cylinder bore having a combustion chamber and a plurality of windows for gas exchange;
a crankcase having an internal chamber;
a crankshaft rotatably mounted in the internal chamber;
a piston having a slidable wall cooperating with the cylinder bore, the piston being linked to a crankshaft through a connecting rod and having a plurality of openings around the piston wall;
arcuate pipes having at least 180 degrees of turning path selectively connecting to the crankcase internal chamber through the cylinder bore and through a piston wall opening, the piston wall opening controlling communication between an arcuate pipe chamber and the crankcase internal chamber, and the piston having means for communicating the arcuate pipes with a supply of pure air;
wherein reciprocating motion of the piston within the cylinder bore produces a timed interchange of gases between the atmosphere, a fuel supply means, the crankcase internal chamber and the combustion chamber.

8. The engine according to claim 7, wherein the piston wall comprises blind compartments and openings over the slidable wall, and wherein gas exchange timing is controlled by reciprocating motion of the piston within the cylinder bore.

9. The engine according to claim 7, wherein the cylinder bore has at least one air inlet window for the induction of pure air inside the arcuate pipes.

10. The engine according to claim 7, wherein the crankcase internal chamber is not in permanent communication with the arcuate pipe chamber.

11. A stratified scavenged two-cycle internal combustion engine, comprising:
a cylinder block having a cylinder bore having a combustion chamber and a plurality of windows;
a crankcase having an internal chamber;
a crankshaft rotatably mounted in the internal chamber;
a piston linked to the crankshaft and movable within the cylinder bore;
arcuate pipes having an at least partially circular internal passage connecting the internal chamber of the crankcase to the cylinder bore on opposing sides of the piston such that gases from the crankcase are separated into heavy and light components by centrifugal force in traveling from the internal chamber to the cylinder bore; and
air inlet ports selectively discharging clean air inside a chamber of the arcuate pipes;
wherein the arcuate pipes provide a triple-stratified mixture of scavenging gases.

12. The engine according to claim 11, wherein the arcuate pipes are partially formed into the cylinder block.

13. The engine according to claim 11, wherein the arcuate pipes each have variable section radii.

14. The engine according to claim 11, wherein the arcuate pipes have at least 180 degrees of circular region.

15. The engine according to claim 11, wherein a total volume enclosed by the arcuate pipes is at least about 30% of the engine displacement.

16. The engine according to claim 11, wherein the arcuate pipes include one or more pairs of arcuate pipes.

17. The engine according to claim 11, wherein the piston comprises a set of cavities to communicate the crankcase internal chamber with the arcuate pipes, and cavities to communicate the air inlet ports with the arcuate pipes.

18. The engine according to claim 11, wherein the arcuate pipes have a cross-sectional area that is reduced in the vicinity of an opening of the combustion chamber wherein gas velocity is increased for improved directional dynamics.

19. The engine according to claim 11, wherein the arcuate pipes are substantially identical in structure and are symmetrically disposed on both sides of the cylinder block, perpendicular to the crankshaft.
